(19) United States
(12) Patent Application Publication
(10) Pub. No.: US 2009/0059589 A1
(43) Pub. Date: Mar. 5, 2009

(54) Ambient light system and method for generating ambient light

(75) Inventors: Ling-Hsiu Huang, Tainan County (TW); Lin-Kai Bu, Tainan County (TW)

Correspondence Address: RABIN & Berdo, PC, 1101 14TH STREET, NW, SUITE 500, WASHINGTON, DC, 20005, US

(73) Assignee: HIMAX TECHNOLOGIES LIMITED, Tainan County (TW)

(21) Appl. No.: 11/896,217

(22) Filed: Aug. 30, 2007

(51) Int. Cl. F21V 99/00

(52) U.S. Cl. 362/253

(57) ABSTRACT

An ambient light system for a display device is provided. The ambient light system comprises a number of ambient light sources, a video ambient decision unit, an audio level detector, a pattern generator and an ambient light controller. The ambient light sources surround the display device. The video ambient decision unit is for generating a number of display parameters based on the displaying colors and the intensities of the pixels, which are neighboring the ambient light sources, of the display device. The audio level detector is for detecting an input audio signal, which is inputted into the display device, to obtain a detected level. The pattern generator is for generating an ambient light pattern based on the detected level. The ambient light controller is for controlling the ambient light sources to generate ambient light based on the ambient light pattern and the display parameters.

### BACKGROUND OF THE INVENTION

1. Field of the Invention

The invention relates in general to an ambient light system and a method for generating an ambient light, and more particularly to an ambient light system and a method for generating an ambient light for a display device.

2. Description of the Related Art

A traditional digital display device includes a display panel and speaker for displaying the video and playing the audio signal respectively. However, the traditional display device is only used to display the video content without any special effect, which is unexcited. Therefore, how to design a digital display device capable of providing special effect while displaying the video content has become an imminent goal to achieve.

### SUMMARY OF THE INVENTION

The invention is directed to an ambient light system for a display device. While a video is played by the display device, the displaying colors and the intensities of the pixels of the display device change in response to the video content, and the ambient light system controls ambient light sources surrounding the display device to generate ambient light accordingly.

According to (a first aspect of) the present invention, an ambient light system for a display device is provided. The ambient light system comprises a number of ambient light sources, a video ambient decision unit, an audio level detector, a pattern generator and an ambient light controller. The ambient light sources surround the display device. The video ambient decision unit is for generating a number of display parameters based on the displaying colors and the intensities of the pixels, which are neighboring the ambient light sources, of the display device. The audio level detector is for detecting an input audio signal, which is inputted into the display device, to obtain a detected level. The pattern generator is for generating an ambient light pattern based on the detected level. The ambient light controller is for controlling the ambient light sources to generate ambient light based on the ambient light pattern and the display parameters.

According to (a second aspect of) the present invention, a method for generating an ambient light of a couple of ambient light sources in a display device is provided. The method comprises the following steps. First, the level of an input audio signal, which is inputted into the display device, is detected, so as to generate a detected level. Next, an ambient light pattern is generated based on the detected level. Then, the ambient light pattern and a couple of display parameters corresponding to the displaying colors and the intensities of pixels, which are neighboring the ambient light sources, of the display device are inputted into the ambient light sources to generate the ambient light.

According to (a third aspect on the present invention, an ambient light system for a display device is provided. The ambient light system comprises a number of ambient light sources, a video ambient decision unit and an ambient light controller. The ambient light sources surround the display device. The video ambient decision unit is for generating a number of display parameters based on the displaying colors and the intensities of the pixels, which are neighboring the ambient light sources, of the display device. The ambient light controller is for controlling the ambient light sources based on the display parameters.

The invention will become apparent from the following detailed description of the preferred but non-limiting embodiments. The following description is made with reference to the accompanying drawings.

### BRIEF DESCRIPTION OF THE DRAWINGS

FIG. 1 is the block diagram of the ambient light system according to the first embodiment of the invention.

FIG. 2 shows the ambient light system according to the second embodiment of the invention.

FIG. 3 shows a method for generating ambient light of the ambient light sources used in the ambient light system.

### DETAILED DESCRIPTION OF THE INVENTION

### First Embodiment

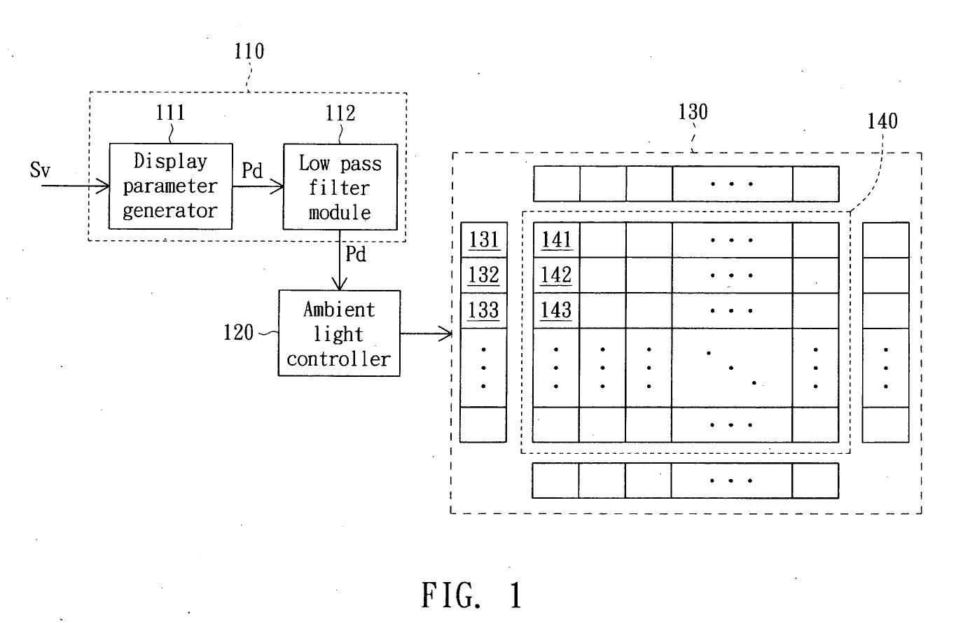

FIG. 1 is the block diagram of the ambient light system according to the first embodiment of the invention. Refer to FIG. 1. The ambient light system includes a video ambient decision unit 110, an ambient light controller 120 and a number of ambient light sources 130. The ambient light sources 130 surround the display device. The video ambient decision unit 110 is for generating a number of display parameters Pd based on the displaying colors and the intensities of the pixels neighboring the ambient light sources 130. The ambient light controller 120 is for controlling the ambient light sources 130 to generate ambient light based on the display parameters Pd.

While a video is played by the display device, the displaying colors and the intensities of the pixels of the display device change in response to the video content, the ambient light system controls the ambient light sources 130 to change the displaying colors and the intensities of ambient light in response.

In this embodiment, the ambient light sources 130 surround the display panel 140 of the display device. The display panel 140 is divided into a number of display blocks. The display blocks 141,142 and 143 are three of the display blocks. The video ambient decision unit 110 generates the display parameter Pd for each ambient light source based on the displaying colors and the intensities of the pixels in the display blocks neighboring each ambient light source.

Refer to FIG. 1. The ambient light sources 131,132 and 133 are three of the ambient light sources 130. Take the generation of the display parameter Pd for the ambient light source 132 as an example. The video ambient decision unit 110 generates the display parameter Pd for the ambient light source 132 based on the display colors and the intensities of the pixels in the display blocks near the ambient light source 132, for example, the display block 142, or other display blocks near it, for example, the display blocks 141 and 143. The video ambient decision unit 110 generates the display parameters Pd for the other ambient light sources in the similar way to the generation of the display parameter Pd for the ambient light source 132.

In this embodiment, the video ambient decision unit 110 includes a display parameter generator 111. The display parameter generator 111 respectively generates the display parameter Pd for each ambient light source by emphasizing the displaying colors and the intensities of the pixels near each ambient light source. The display parameter generator 111 then outputs the display parameter Pd to the ambient light controller 120 to control the ambient light sources accordingly.

In this embodiment, the display parameter Pd includes a red parameter, a green parameter and a blue parameter. The ambient light controller 120 controls each ambient light source to generate ambient light with the intensities of red, green, and blue colors respectively according to the red, the green and the blue parameters corresponding to each ambient light source.

Take the generation of the display parameter for the ambient light source 132 as an example. The display parameter generator 111 emphasizes the display colors and the intensities of the pixels near the ambient light source 132, that is, the intensities of the red, the green and the blue colors thereof, to generate the red, the green, and the blue parameters for the ambient light source 132. In this embodiment, the display parameter generator 111 calculates the weighting sum of the intensities of the red, the green, and the blue colors of the pixels near the ambient light source 132 as the red, the green and the blue parameters for the ambient light source 132. In the weighting sum, the more a pixel of the display device is close to the ambient light source 132, the more the intensities of the red, green, and blue color of the pixel are weighted. Thus, the display parameter generator 111 determines the displaying color and the intensity of the ambient light generated by the ambient light source 132.

In the embodiment, when the display parameter for the ambient light source 132 are obtained, the ambient light controller 120 controls the ambient light source 132 to generate ambient light accordingly.

In the embodiment, the video ambient decision unit 110 further includes a low-pass filter (LPF) module 112. Before the display parameters Pd obtained by the display parameter generator 111 is outputted to the ambient light controller, the LPF module 112 low-pass filters the display parameter Pd, outputted by the display parameter generator 111, for each ambient light source with reference to the display parameters Pd of other ambient light sources neighboring the each ambient light source. The LPF module 112 then outputs the filtered display parameters Pd to the ambient light controller 120. In the embodiment, the ambient light controller 120 controls the ambient light sources according to the filtered display parameters Pd. By low-pass filtering the display parameter Pd for each ambient light source, the displaying colors and the intensities of ambient light generated by each ambient light source and its neighboring ambient light sources can be more consistent.

Take the low-pass filter operation applied on the display parameter Pd for the ambient light source 132 as an example. The LPF module 112 low-pass filters the display parameter Pd, outputted by the display parameter generator 111, for the ambient light source 132 with reference to the display parameters Pd for the ambient light sources near the ambient light source 132, for example, the display parameters Pd for the ambient light sources 131 and 133.

For example, the LPF module 112 can be designed to calculate the mean of the display parameters Pd for the ambient light sources 131, 132 and 133 and output the filtered display parameter Pd for the ambient light source 132 as the mean to the ambient light controller 120, so as to low-pass filter the display parameter Pd for the ambient light source 132.

In this embodiment, the LPF module 112 low-pass filters the red, the green and the blue parameters for each ambient light source with reference to the red, the green and the blue parameters for other ambient light sources neighboring each ambient light source. The LPF module 112 thus outputs the filtered red, green, blue parameters to the ambient light controller 120, so as to control the ambient light sources 130 accordingly.

In this embodiment, the generation of the display parameter Pd for the ambient light source 132 is taken as example. The generation of the display parameters Pd for other ambient light sources is similar thereto.

In this embodiment, the video ambient decision unit 110 receives an input video signal Sv, which is also inputted to the display device, and generates the display parameters Pd accordingly. The displaying colors and the intensities of the pixels of the device are also determined accordingly.

The ambient light system according to the first embodiment controls the ambient light sources 130 to generate ambient light based on the displaying colors and the intensities of the pixels near each ambient light source. By weighting the displaying colors and the intensities of the pixels neighboring each ambient light source, the video ambient decision unit 110 controls the displaying color and the intensity of ambient light generated by each ambient light source to be close to those of the pixels near each ambient light source. By low-pass filtering the display parameter Pd for each ambient light source, the displaying color and the intensity of ambient light generated by each ambient light source are consistent with those generated by other ambient light sources neighboring each ambient light source.

Thus, when the video is played by the display device, the display colors and the intensities of ambient light generated by the ambient light sources 130 are changed in response to the video content.

### Second Embodiment

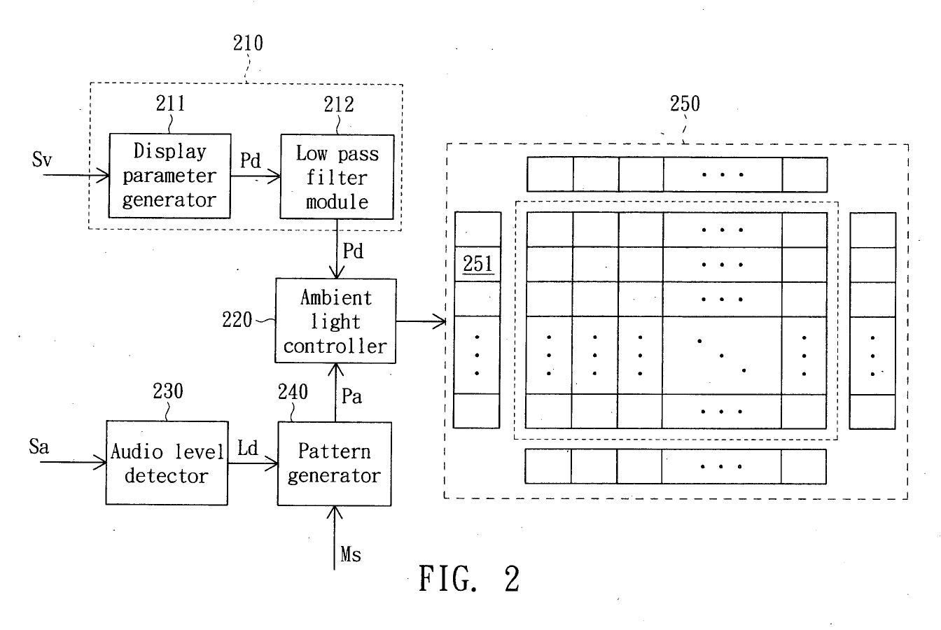

FIG. 2 shows the ambient light system according to the second embodiment of the invention. Except including the video ambient decision unit 210 and the ambient light controller 220, which are similar with those in the ambient light system in FIG. 1, the ambient light system in FIG. 2 further includes an audio level detector 230 and a pattern generator 240. The video ambient decision unit 210 is the same as the video ambient decision unit 110. The display parameters Pd for the ambient light sources 250 are generated in the same way as those for the ambient light sources 130.

The audio level detector 230 detects an input audio signal Sa, which is inputted to the display device, to obtain a detected level Ld. The pattern generator 240 generates an ambient light pattern Pa based on the detected level Ld. The ambient light controller 220 controls the ambient light sources 250 to generate ambient light based on the ambient light pattern Pa and the display parameters Pd.

In this embodiment, the pattern generator 240 determines whether the detected level Ld is over a threshold and provides the ambient light pattern Pa to the ambient light controller 220 when the detected level Ld is over the threshold. Thus, the ambient light controller 220 controls the ambient light sources to generate ambient light based on the ambient light pattern Pa in response to the input audio signal Sa.

In this embodiment, the pattern generator 240 is used for generating the ambient light pattern Pa based on the detected level Ld with reference to a selected operation mode Ms in response to an operational event. In this embodiment, the operational event is triggered by a user. The ambient light controller 220 can control the ambient light sources 240 to generate ambient light with special effect in response to the operational event.

In this embodiment, the ambient light pattern Pa includes a number of coefficients, each of which corresponds to one of the ambient light sources 250. For example, the ambient light pattern Pa corresponding to the selected operation mode Ms is for generating a flickering ambient light effect when the detected level is over the threshold. In this example, the coefficients of ambient light pattern Pa can firstly be set as 0 and later set as 1 in a time interval. The ambient light controller 220 then multiplies each of the display parameters Pa with its corresponding coefficients of the ambient light pattern Pa, and controls the ambient light sources 250 based on the products of the multiplication. The ambient light sources 250 therefore generate the ambient light based on the display parameters Pd and the ambient light pattern Pa.

Take the ambient light generated by the ambient light sources 251 as an example. The display parameter Pd corresponding to the ambient light sources 251 includes the red, the green and the blue parameters. In this embodiment, the red, green and the blue parameters are 8-bit grey value, for example, 55, 125 and 255. At one time interval, the coefficient corresponding to the ambient light source 251 is first set as 0. The ambient light controller 220 multiplies the red, green, and the blue parameters 55, 125 and 255 with 0 to obtain the products as 0, 0 and 0. The ambient light controller 220 then control the ambient light source 251 to generate the ambient light with the intensities of the red, the green and the blue colors as the products 0, 0 and 0. That is, the ambient light controller 220 controls the ambient light source 251 not to generate the ambient light at the time interval.

Similarly, the coefficient corresponding to the ambient light source 251 Pa is later set as 1. The red, the green and the blue parameters are, for example, 60, 130 and 240 at the next time interval. The ambient light controller 220 multiplies the red, green, and the blue parameters 60, 130 and 250 with 1 to obtain the products as 60, 130 and 250. The ambient light controller 220 then control the ambient light source 251 to generate the ambient light with the intensities of the red, the green and the blue colors as the products 60, 130 and 250. That is, the ambient light controller 220 controls the ambient light source 251 to generate the ambient light at the next time interval.

Therefore, the ambient light controller 220 combines the display parameter Pd and the ambient light pattern Pa to control the ambient light source 251 to provide flickering ambient light effect.

In this embodiment, the ambient light controller 220 controls other ambient light sources in the similar manner. In the example, the coefficients of the ambient light pattern Pa are designed as 0 or 1. Thus, the ambient light controller 220 can controls the ambient light sources 250 to generate ambient light with at least two different intensities when the detected level is over the threshold, so as to provide flickering ambient light effect according to the ambient pattern Pa corresponding to the selected operation mode Ms. However, the ambient light effect is not limited thereto. The ambient light pattern can be designed differently by arranging the coefficients differently, so as to enable the ambient light sources to generate different ambient light effects.

For example, the coefficient corresponding to each ambient light source can be arranged differently at one time point, so as to provide un-uniform ambient light effect, in response to different detected level.

The ambient light system in this embodiment controls the ambient fight sources not only with reference to the displaying colors and the intensities of the pixels neighboring the ambient light sources, but also with reference to the ambient pattern selected by a user in response to the level of the input audio signal. Therefore, the ambient light system in this embodiment can control the ambient light sources to provide more variety of ambient light.

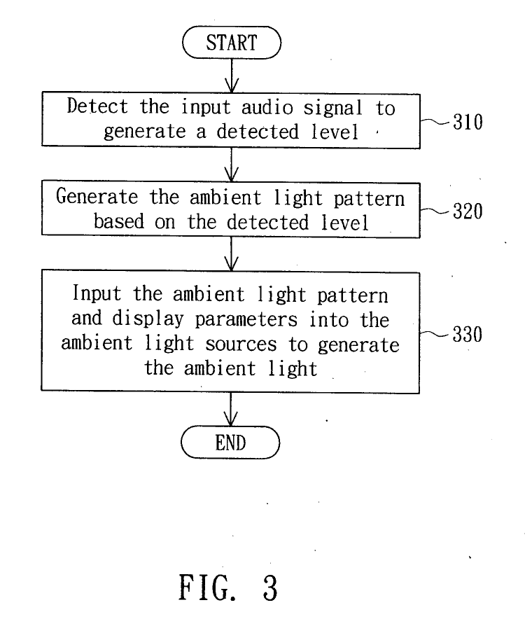

FIG. 3 shows a method for generating ambient light of the ambient light sources 240 used in the ambient light system in FIG. 2. Refer to FIG. 3. In step 310, detect the input audio signal Sa to generate a detected level Ld. Next, in step 320, generate the ambient light pattern Pa based on the detected level Ld. Then, in step 330, input the ambient light pattern Pa and display parameters Pd into the ambient light sources to generate the ambient light.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An ambient light system for a display device, comprising:
a plurality of ambient light sources surrounding the display device;
a video ambient decision unit for generating a plurality of display parameters based on the displaying colors and the intensities of the pixels, which are neighboring the ambient light sources, of the display device;
an audio level detector for detecting an input audio signal, which is inputted into the display device, to obtain a detected level;
a pattern generator for generating an ambient light pattern based on the detected level; and
an ambient light controller for controlling the ambient light sources to generate ambient light based on the ambient light pattern and the display parameters.

2. The ambient light system according to claim 1, wherein the display panel of the display device is divided into a plurality of display blocks, the video ambient decision unit generates the display parameter for each of the ambient light sources based on the displaying colors and the intensities of pixels in the display block neighboring each of the ambient light sources.

3. The ambient light system according to claim 1, wherein each of the display parameters comprises a red parameter, a green parameter and a blue parameter respectively corresponding to the intensities of red, green, and blue colors of ambient light generated by each of the ambient light sources.

4. The ambient light system according to claim 3, wherein the video ambient decision unit comprises a display parameter generator for weighting the intensities of the red, the green and the blue colors of the pixels near each of the ambient light sources and calculating the weighting sum of the weighted intensities of the red, the green and the blue colors of the pixels near each of the ambient light sources as the red, the green and the blue parameters for each of the ambient light sources.

5. The ambient light system according to claim 1, wherein the video ambient decision unit comprises a display parameter generator for respectively generating the display parameter for each of the ambient light sources by emphasizing the displaying colors and the intensities of the pixels near each of the ambient light sources.

6. The ambient light system according to claim 5, wherein the video ambient decision unit further comprises a low-pass filter (LPF) module for respectively low-pass filtering the display parameter for each of the ambient light sources with reference to the display parameters of other ambient light sources neighboring each of the ambient light sources and outputting the filtered display parameter for each of the ambient light sources;
wherein the ambient light controller controls the ambient light sources based on the filtered display parameters and the ambient light pattern.

7. The ambient light system according to claim 1, wherein the pattern generator determines whether the level of the input audio signal is over a threshold, and provides the ambient light pattern to the ambient light controller when the level of the input audio signal is over the threshold.

8. The ambient light system according to claim 1, wherein the pattern generator is used for generating the ambient light pattern based on the level of the input audio signal with reference to a selected operation mode in response to an operational event.

9. The ambient light system according to claim 8 wherein the selected operation mode is referred to generate the corresponding ambient light pattern to the ambient light controller, the ambient light controller controls the ambient light sources to generate ambient light with at least two different intensities in one time interval based on the corresponding ambient light pattern, so as to provide flickering ambient light effect.

10. The ambient light system according to claim 8, wherein the selected operation mode is referred to generate the corresponding ambient light pattern to the ambient light controller, the ambient light controller controls the ambient light sources to generate ambient light with at least two different intensities at substantially the same time point based on the corresponding ambient light pattern, so as to provide non-uniform ambient light effect.

11. The ambient light system according to claim 1, wherein the video ambient decision unit receives an input video signal, which is inputted to the display device and comprises the displaying colors and the intensities of the pixels, and generates the display parameters accordingly.

12. A method for generating an ambient light of a plurality of ambient light sources in a display device, comprising the following steps of:
detecting the level of an input audio signal, which is inputted into the display device, to generate a detected level;
generating an ambient light pattern based on the detected level; and
inputting the ambient light pattern and a plurality of display parameters corresponding to the displaying colors and the intensities of pixels, which are neighboring the ambient light sources, of the display device into the ambient light sources to generate the ambient light.

13. The method according to claim 12, wherein the display parameter for each of the ambient light sources emphasizes the displaying colors and the intensities of the pixels near each of the ambient light sources.

14. The method according to claim 12, wherein the display parameter for each of the ambient light sources corresponds to the display parameters of other ambient light sources neighboring each of the ambient light sources.

15. The method according to claim 12, wherein in the step of generating the ambient pattern, generate the ambient light pattern based on the detected level with reference to a selected operation mode in response to an operational event.

16. The method according to claim 15, wherein the selected operation mode is referred to generate the ambient light pattern to control the ambient light sources to generate the ambient light with at least two different intensities in one time interval, so as to generate the flickering ambient light effect.

17. The method according to claim 15, wherein the selected operation mode is referred to generate the ambient light pattern to control the ambient light sources to generate the ambient light with at least two different intensities at substantially the same time point, so as to generate the non-uniform ambient light effect.

18. An ambient light system for a display device, comprising:
a plurality of ambient light sources surrounding the display device;
a video ambient decision unit for generating a plurality of display parameters based on the displaying colors and the intensities of the pixels, which are neighboring the ambient light sources, of the display device; and
an ambient light controller for controlling the ambient light sources based on the display parameters.

19. The ambient light system according to claim 18, wherein the video ambient decision unit comprises a display parameter generator for respectively generating the display parameter corresponding to each of the ambient light sources by weighting the displaying colors and the intensities of the pixels near each of the ambient light sources.

20. The ambient light system according to claim 19, wherein the video ambient decision unit further comprises a low-pass filter (LPF) module, for filtering the display parameter for each of the ambient light sources with reference to the display parameters of other ambient light sources neighboring each of the ambient light sources.

21. The ambient light system according to claim 18, wherein the display panel of the display device is divided into a plurality of display blocks, the video ambient decision unit generates the display parameter for each of the ambient light sources based on the displaying colors and the intensities of pixels in the display block neighboring each of the ambient light sources.

22. The ambient light system according to claim 18, wherein each of the display parameters comprises a red parameter, a green parameter and a blue parameter respectively corresponding to the intensities of red, green, and blue colors of each of the ambient light sources.

23. The ambient light system according to claim 22, wherein the video ambient decision unit comprises a display parameter generator for weighting the intensities of the red, the green and the blue colors of the pixels near each of the ambient light sources and calculating the weighting sum of the intensities of the red, the green and the blue colors thereof as the red, the green and the blue parameters for each of the ambient light sources.

24. The ambient light system according to claim 18, wherein the video ambient decision unit receives an input video signal, which is inputted to the display device and corresponds to the displaying colors and the intensities of the pixels, and generates the display parameters accordingly.
